(19) United States
(12) Patent Application Publication
(10) Pub. No.: US 2011/0187925 A1
(43) Pub. Date: Aug. 4, 2011

(54) VIDEO OUTPUT APPARATUS AND VIDEO OUTPUT METHOD

(75) Inventor: Atsushi ONODA, Tokyo (JP)

(73) Assignee: Kabushiki Kaisha Toshiba, Tokyo (JP)

(21) Appl. No.: 13/015,424

(22) Filed: Jan. 27, 2011

(30) Foreign Application Priority Data
Jan. 29, 2010 (JP) 2010-019700

(51) Int. Cl. H04N 7/00

(52) U.S. Cl. 348/468; 348/E07.033

(57) ABSTRACT

According to one embodiment, a video output apparatus includes a first information receiving module, a second information receiving module, an audio output module, and a video output module. The first information receiving module is configured to receive first video information and audio information. The second information receiving module is configured to receive second video information and subtitle information. The audio output module is configured to output an audio based on the audio information. The video output module is configured to display a multi-picture screen comprising a first region for displaying a first picture based on the first video information, a second region for displaying a second picture based on the second video information, and a third region for displaying a subtitle image based on the subtitle information. The third region is arranged within a given horizontal range where the second region exists, and does not overlap with the second region.

### CROSS REFERENCE TO RELATED APPLICATION(S)

This application is based upon and claims the benefit of priority from Japanese Patent Application No. 2010-019700 filed on Jan. 29, 2010, the entire contents of which are incorporated herein by reference.

### BACKGROUND

1. Field

Embodiments described herein relate generally to a video output apparatus and a video output method which output video and a subtitle simultaneously.

2. Description of the Related Art

In recent years, with the increase of the size of display panels, TV receivers have come to be able to display pieces of video of multiple programs in the display area of a display monitor (hereinafter referred to as multi-picture screen). On the other hand, it is an ordinary procedure to output audio that corresponds to only one program while such multi-picture screen is performed. As a result, it is difficult for the user of a TV receiver to recognize the content of a program for which no audio is output.

In the above circumstances, techniques have been disclosed which allow the user of a TV receiver to easily recognize the content of a program for which no audio is output.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary block diagram showing the configuration of a TV receiver (video output apparatus) according to the embodiment;

FIG. 2 is an exemplary diagram showing a system configuration of components which are provided in a signal processing controller and perform DEMUX processing and picture generation processing;

FIG. 3 is an exemplary flowchart showing the DEMUX processing and the picture generation processing; and

FIGS. 4A and 4B and FIGS. 5A-5C are exemplary diagrams showing multi-picture screen which are produced according to the process of FIG. 3.

### DETAILED DESCRIPTION

In general, according to one embodiment, a video output includes a first information receiving module, a second information receiving module, an audio output module, and a video output module. The first information receiving module is configured to receive first video information and audio information. The second information receiving module is configured to receive second video information and subtitle information. The audio output module is configured to output an audio based on the audio information. The video output module is configured to display a multi-picture screen, the multi-picture screen comprising a first region for displaying a first picture based on the first video information, a second region for displaying a second picture based on the second video information, and a third region for displaying a subtitle image based on the subtitle information. The third region is arranged within a given horizontal range where the second region exists, and the third region does not overlap with the second region.

An exemplary embodiment of the present invention will be hereinafter described with reference to the drawings.

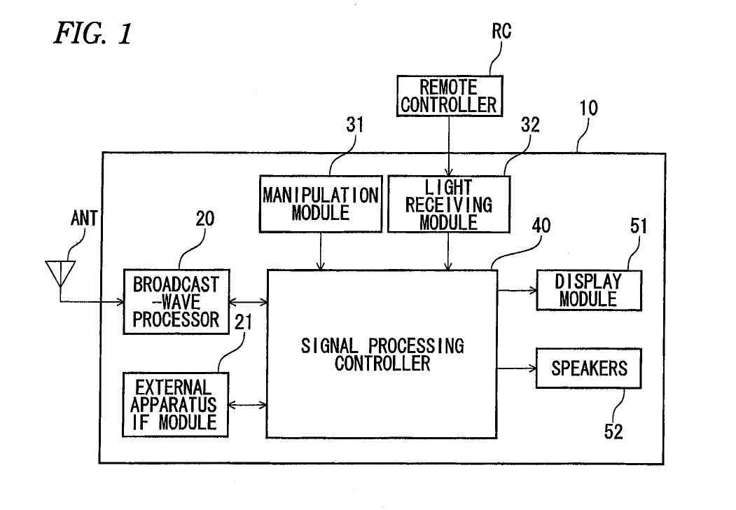

FIG. 1 is an exemplary block diagram showing the configuration of a TV receiver 10 (video output apparatus) according to the embodiment.

The TV receiver 10 according to the embodiment includes a broadcast-wave processor 20, an external apparatus IF module 21, a manipulation module 31, a light receiving module 32, a signal processing controller 40, a display module 51, speakers 52, etc. An antenna ANT is connected to the broadcast-wave processor 20. The light receiving module 32 exchanges information with a remote controller RC. The remote controller RC uses infrared light or wireless and is provided with a manipulation key (not shown) to be used for switching to a mode in which the TV receiver 10 displays pieces of video of multiple programs simultaneously on the single screen. In the following description, display in which pieces of video of multiple programs are displayed simultaneously on the single screen will be referred to as multi-picture screen.

The TV receiver 10 according to the embodiment outputs multiple pieces of video and audio on the basis of pieces of information of programs received from the broadcast-wave processor 20 or the external apparatus IF module 21. The TV receiver 10 also outputs a subtitle(s) on the basis of the pieces of information of the programs. The TV receiver 10 performs multi-picture screen in which pieces of video of multiple programs are displayed simultaneously on the single display screen and a subtitle(s) corresponding to part of the pieces of video is shown in the vicinity of it (or them).

The broadcast-wave processor 20 is equipped with tuners and decoders for processing terrestrial digital broadcast waves, satellite digital broadcast waves, and terrestrial analog broadcast waves received by the antenna ANT. The broadcast-wave processor 20 receives signals received by the antenna ANT, tunes in to a signal on a particular channel among the received signals, and performs demodulation and other processing on the thus-selected signal. The broadcast-wave processor 20 outputs a transport signal (hereinafter referred to as a TS signal) that contains program audio-video information, program-related information such as a program name to the signal processing controller 40. Multiple broadcast-wave processors 20 may be provided.

The external apparatus IF module 21 is equipped with an information extracting module for extracting information according to any of various standards such as the HDMI (registered trademark) standard, the USB standard and the IEEE 1394 standard. The external apparatus IF module 21 receives information containing audio-video information of a content and content-related information such as a content name from an external apparatus connected to a connection terminal that complies with any of the above standards or a storage medium such as an external HDD or a memory card, and outputs a TS signal that is based on the received information to the signal processing controller 40.

The manipulation module 31 has manipulation keys and outputs manipulation information corresponding to any of those manipulation keys to the signal processing controller 40. Likewise, the light receiving module 32 receives light that carries an input signal from the remote controller RC and outputs manipulation information corresponding to the received input signal to the signal processing controller 40. The manipulation module 31 and/or the remote controller RC has a multi-picture key (not shown) for switching to multi-picture screen from display in which video of one program is displayed on the single screen, and other keys.

The signal processing controller 40 performs multiple pieces of processing using components provided in itself or connected to it. For example, the signal processing controller 40 performs, according to manipulation information supplied from the manipulation module 31 or the light receiving module 32, selection processing of selecting one of TS signals that are input from the input sources such as the broadcast-wave processor 20 and the external apparatus IF module 21. The signal processing controller 40 performs given processing on the TS signal that is input from the selected input source and outputs a resulting video signal and audio signal to the display module 51 and the speakers 52, respectively.

In the embodiment, the signal processing controller 40 performs DEMUX processing of separating and extracting video information, audio information, and subtitle information from a TS signal that is input from the broadcast-wave processor 20 or the external apparatus IF module 21. The signal processing controller 40 performs picture generation processing of generating a signal for multi-picture screen in which multiple pieces of video and a subtitle(s) are arranged at given positions on the single display screen.

The display module 51 is a display module including a display panel for displaying a video signal that is output from the signal processing controller 40. For example, the display module 51 can be a thin, flat display such as an LCD (liquid crystal display) or a PDP (plasma display panel). The display module 51 performs multi-picture screen in which multiple pieces of video and a subtitle(s) are arranged on the single display screen.

The speakers 52 output audio signals that are input from the signal processing controller 40. The speakers 52 may be two speakers for the left and right channels or those speakers plus a subwoofer for output of a low-frequency component of an input signal.

In addition to the above-described components, the TV receiver 10 may also be equipped with a module (not shown) for realizing a network communication function which has a communication processor for performing a communication over a network such as a LAN or a WAN. This module receives information containing audio-video information of a content and content-related information from an information providing source such as a particular server located on the other side of a connected network, and outputs a TS signal that is based on the received information to the signal processing controller 40. The signal processing controller 40 may use a TS signal that is input from this module as one input source.

The TV receiver 10 may also be equipped with a module for exchanging information with an HDD (hard disk drive) in which information is written to and read from recording media (hard disks) or an ODD (optical disc drive) for reading information from an optical disc. This module receives information containing audio-video information of a content and content-related information from the HDD or the ODD and outputs a TS signal that is based on the received information to the signal processing controller 40. The signal processing controller 40 may use a TS signal that is input from this module as one input source.

The embodiment is directed to the TV receiver 10 which is a video output apparatus to which the invention is applied. Alternatively, the invention may be applied to other video output apparatus such as a personal computer, an HDD recorder, a DVD recorder, a portable, mobile terminal device, and an HDD/optical disc recorder. As a further alternative, the invention may be applied to a set-top box etc. which receive not only terrestrial broadcasts and satellite broadcasts but also radio broadcasts and wired broadcasts that are transmitted over the Internet or a cable network and other broadcasts.

Having the above-described configuration, the multiple components provided in the TV receiver 10 according to the embodiment perform DEMUX processing and picture generation processing for pieces of video and a subtitle(s) on the basis of TS signals that are input from the broadcast-wave processor 20 and the external apparatus IF module 21. In multi-picture screen that is performed on the basis of a signal generated by the picture generation processing, pieces of video of multiple programs are displayed simultaneously on the single display screen and a subtitle(s) corresponding to part of those pieces of video is shown in the vicinity of it (or them). As such, the TV receiver 10 can output video of each content in its entirety without blocking any portion of it and increase the legibility of a subtitle corresponding to it. These advantages are realized mainly by the signal processing controller 40's performing multiple pieces of processing.

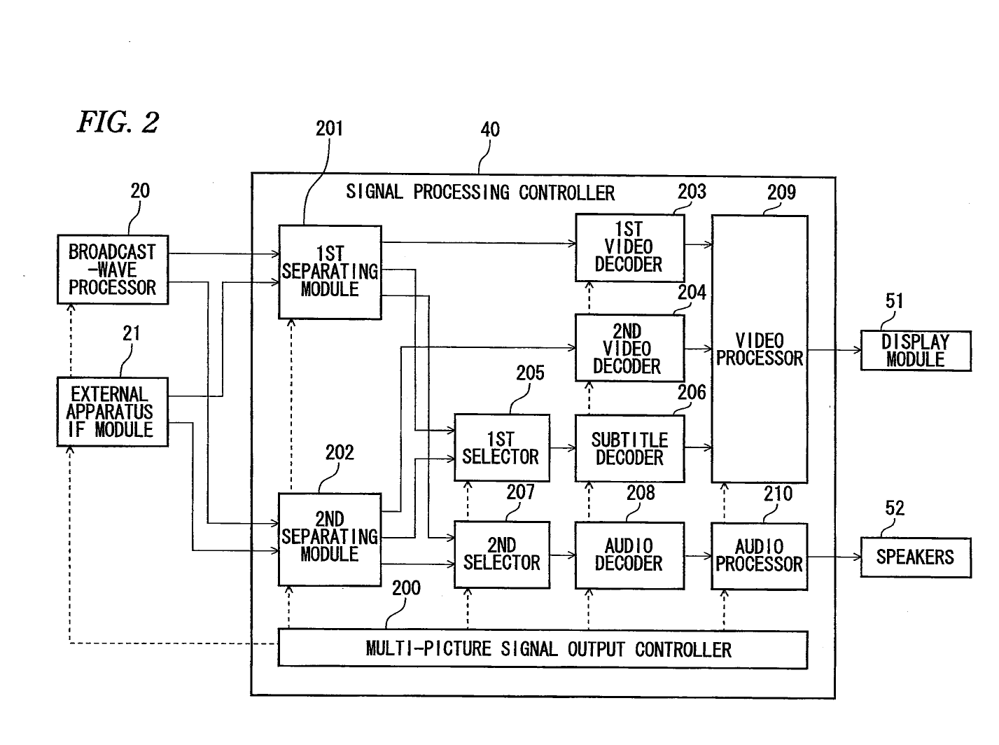

Next, components that are provided in the signal processing controller 40 described above with reference to FIG. 1 and perform DEMUX processing and picture generation processing for pieces of video and a subtitle(s) of programs will be described with reference to FIG. 2.

FIG. 2 shows a system configuration of components which are provided in the signal processing controller 40 and perform DEMUX processing and picture generation processing.

As described above, the picture generation processing according to the embodiment generates a signal for multi-picture screen in which pieces of video of multiple programs are displayed simultaneously on the single display screen. Therefore, the DEMUX processing according to the embodiment is performed on multiple TS signals that are input from the broadcast-wave processor 20 or the external apparatus IF module 21.

The signal processing controller 40 is equipped with a multi-picture signal output controller 200, a first separating module 201, a second separating module 202, a first video decoder 203, a second video decoder 204, a first selector 205, a subtitle decoder 206, a second selector 207, an audio decoder 208, a video processor 209, an audio processor 210, etc.

The multi-picture signal output controller 200 performs controls according to manipulation information that is supplied from the manipulation module 31 or from the remote controller RC via the light receiving module 32 so that the above components (described below), the broadcast-wave processor 20 or the external apparatus IF module 21, etc. perform DEMUX processing and picture generation processing. Therefore, the above components operate under the control of the multi-picture signal output controller 200. The multi-picture signal output controller 200 calculates arrangement positions of images on the screen which are represented by a signal generated by the picture generation processing, and outputs calculation results to the video processor 209.

The first separating module 201 performs DEMUX processing of separating and extracting video information, audio information, and subtitle information from each TS signal that is input from the broadcast-wave processor 20 or the external apparatus IF module 21. The first separating module 201 outputs the video information, the subtitle information, and the audio information extracted by the DEMUX processing to the first video decoder 203, the first selector 205, and the second selector 207, respectively. For example, the first separating module 201 can extract video information, audio information, and subtitle information by separating each received TS signal on a PES-by-PES basis (PES: packetized elementary stream).

Like the first separating module 201, the second separating module 202 performs DEMUX processing of separating and extracting video information, audio information, and subtitle information from each TS signal that is input from the broadcast-wave processor 20 or the external apparatus lF module 21. The second separating module 202 outputs the video information, the subtitle information, and the audio information extracted by the DEMUX processing to the second video decoder 204, the first selector 205, and the second selector 207, respectively.

The first video decoder 203 performs MPEG decoding on the video information that is input from the first separating module 201, and outputs a resulting video signal to the video processor 209.

The second video decoder 204 performs MPEG decoding on the video information that is input from the second separating module 202, and outputs a resulting video signal to the video processor 209.

The first selector 205 selects one of the pieces of subtitle information that are input from the first separating module 201 and the second separating module 202, and outputs the selected subtitle information to the subtitle decoder 206.

The subtitle decoder 206 performs decoding on the subtitle information that is input from the first selector 205, and outputs a resulting subtitle video signal to the video processor 209.

The second selector 207 selects one of the pieces of audio information that are input from the first separating module 201 and the second separating module 202, and outputs the selected audio information to the audio decoder 208.

The audio decoder 208 performs MPEG decoding on the audio information that is input from the second selector 207, and outputs a resulting audio signal to the audio processor 210.

The video processor 209 performs picture generation processing of generating a signal for multi-picture screen by combining the video signal(s) that is input from the first video decoder 203, the video signal(s) that is input form the second video decoder 204, and the subtitle signal(s) that is input from the subtitle decoder 206. Furthermore, functioning as a graphic renderer, the video processor 209 generates the signal for multi-picture screen on the basis of the received video signals and subtitle signal(s) so that corresponding pieces of video and a corresponding subtitle(s) are arranged at given positions on the single display screen. The video processor 209 arranges the pieces of video and the subtitle(s) on the basis of the calculation results that are input from the multi-picture signal output controller 200. The video processor 209 outputs, to the display module 51, the video signal for multi-picture screen in which the multiple pieces of video are displayed simultaneously on the single display screen and the subtitle(s) corresponding to part of the multiple pieces of video is shown in the vicinity of it (or them). The video processor 209 generates the signal for multi-picture screen so that the sizes of the pieces of video displayed are changed according to given conditions.

Having such functions as a DAC (digital-to-analog converter), a volume adjuster, an equalizer, an amplifier, etc., the audio processor 210 performs these functions on the audio signal that is input from the audio decoder 208 and outputs resulting signals to the speakers 52.

Having the system configuration of the above components, the signal processing controller 40 generates a signal for multi-picture screen in which multiple pieces of video are displayed simultaneously on the single display screen and a subtitle(s) corresponding to part of the multiple pieces of video is shown in the vicinity of it (or them), on the basis of multiple TS signals that are input from the broadcast-wave processor 20 or the external apparatus IF module 21. As a result, the TV receiver 10 according to the embodiment can not only output pieces of video of multiple contents in their entirety without blocking any portions of them but also increase the legibility of a subtitle(s) corresponding to part of the multiple pieces of video.

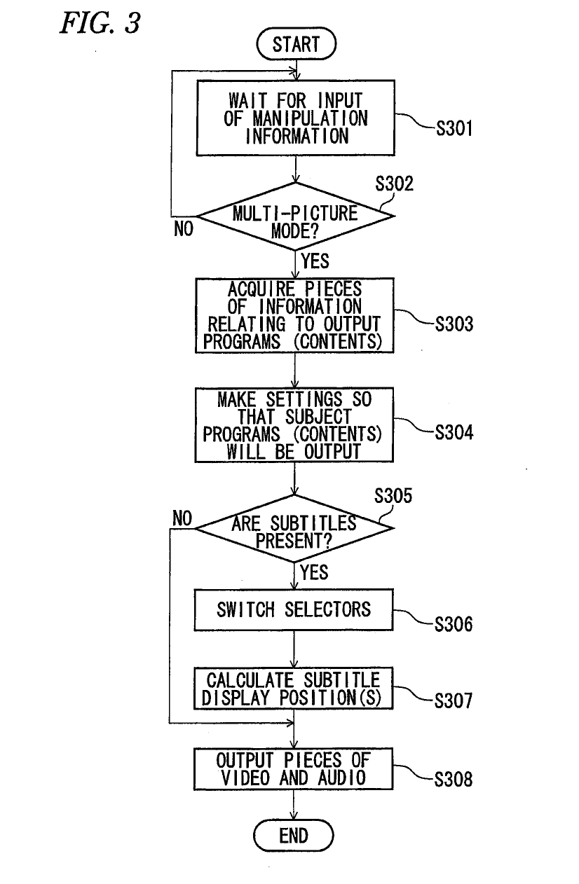

Next, a DEMUX processing and a picture generation processing which are executed by the components of the signal processing controller 40 described above with reference to FIG. 2 will be described with reference to FIG. 3.

FIG. 3 is an exemplary flowchart of the DEMUX processing and the picture generation processing.

First at step S301, the process waits for input of manipulation information through a manipulation key provided in the manipulation module 31 or the remote controller RC (input is made via the light receiving module 32. At step S302, it is determined whether or not the input manipulation information is information for switching to the multi-picture mode which was input through the multi-picture key (not shown) or the like. If the input manipulation information is not information for switching to the multi-picture mode (S302: no), the process returns to step S301 to wait for input of manipulation information.

On the other hand, if the input manipulation information is information for switching to the multi-picture mode (S302: yes), at step S303 the multi-picture signal output controller 200 acquires pieces of information relating to output programs. At step S304, the multi-picture signal output controller 200 controls the components so that the programs will be output. At step S305, each of the first separating module 201 and the second separating module 202 determines whether or not the output program has information relating to subtitles.

If there is information relating to subtitles (S305: yes), at step S306 the multi-picture signal output controller 200 controls the first selector 205 and the second selector 207 so that each of them selects information supplied from the first separating module 201 or the second separating module 202. For example, the multi-picture signal output controller 200 controls the first selector 205 and the second selector 207 so that the first selector 205 selects subtitle information that is input from the second separating module 202 and the second selector 207 selects audio information that is input from the first separating module 201.

That is, the video processor 209 receives video information from the first separating module 201 via the first video decoder 203, video information from the second separating module 202 via the second decoder 204, and subtitle information from the second separating module 202 via the first selector 205 and the subtitle decoder 206. The audio processor 210 receives audio information from the first separating module 201 via the second selector 207 and the audio decoder 208.

At step S307, the multi-picture signal output controller 200 calculates a display position, on the screen, according to the number of pieces of vide of the output programs, of a subtitle corresponding to a particular piece(s) of video on the screen on which multiple video signals to be combined together. The multi-picture signal output controller 200 outputs a calculation result to the video processor 209. On the basis of the calculation result indicating the display position received from the multi-picture signal output controller 200, at step S308 the video processor 209 outputs, to the display module 51, a video signal for multi-picture screen in which multiple pieces of video are displayed and a subtitle(s) corresponding to part of the multiple pieces of video is shown in the vicinity of it (or them). The audio processor 210 outputs an audio signal produced through given processing to the speakers 52. The calculation of a display position may be performed by the video processor 209 itself rather than the multi-picture signal output controller 200.

On the other hand, if there is no information relating to subtitles (S305: no), at step S308 the video processor 209 outputs, to the display module 209, a video signal for display in which multiple pieces of video are displayed and no subtitle is shown. The audio processor 210 outputs an audio signal produced through given processing to the speakers 52. In the multi-picture mode, if there is no region large enough to display a subtitle in the vicinity of a video display region, the video processor 209 produces a region to show a subtitle by reducing the video display region.

With the above-described process, a signal for multi-picture screen in which pieces of video of multiple programs are displayed simultaneously on the single display screen and a subtitle(s) corresponding to part of the pieces of video is shown in the vicinity of it (or them). As such, the TV receiver 10 according to the embodiment can output video of each content in its entirety without blocking any portion of it and increase the legibility of a subtitle corresponding to it.

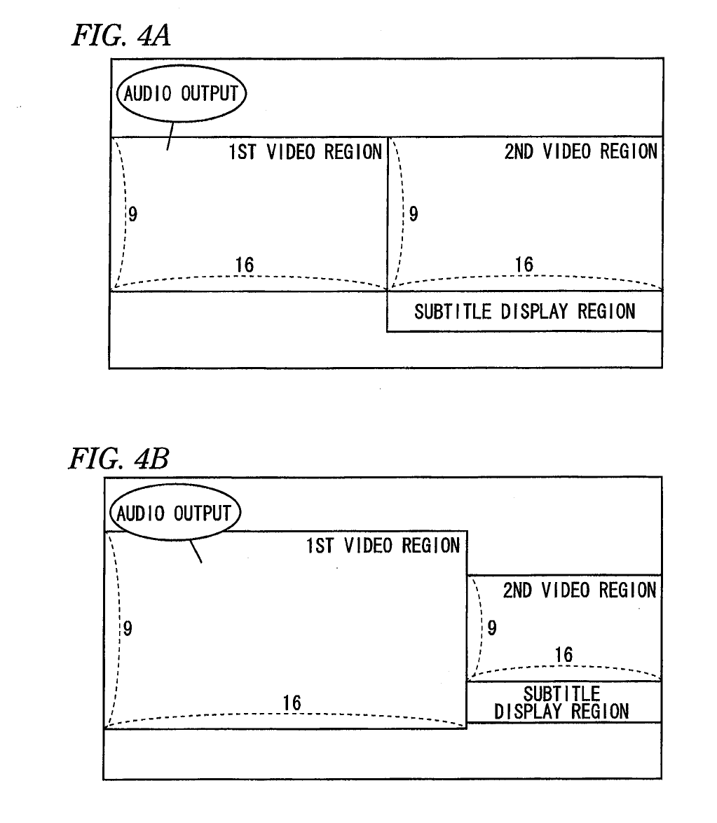

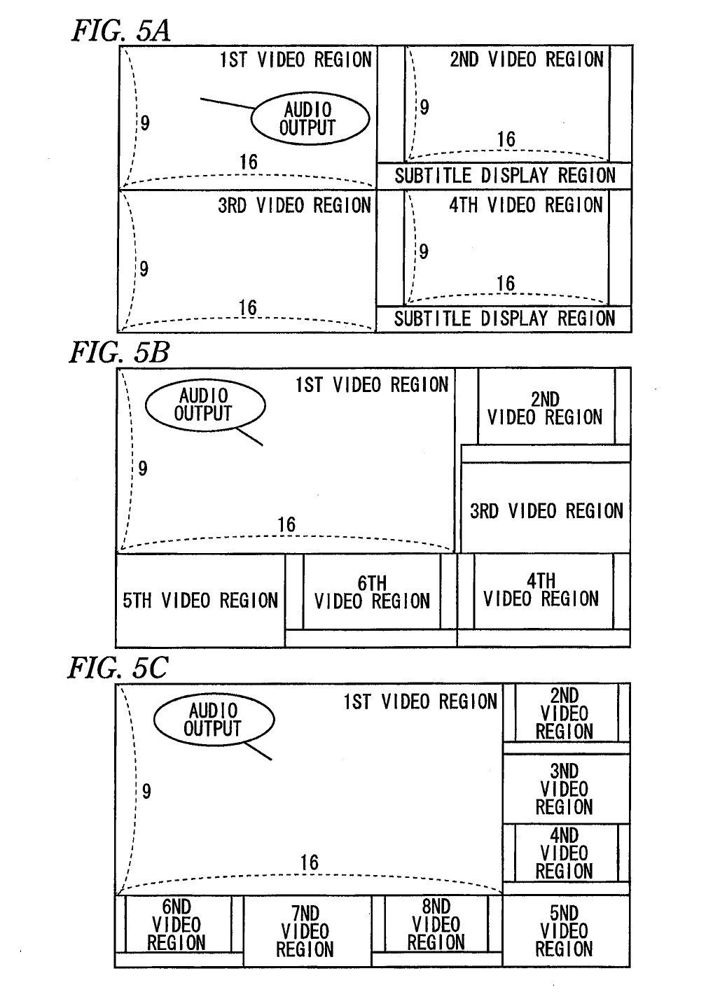

Next, specific examples of multi-picture screen which are produced according to the process of FIG. 3 and in which pieces of video of multiple programs are displayed simultaneously on the single display screen and a subtitle(s) corresponding to a particular piece(s) of video displayed is shown in the vicinity of it (or them) will be described with reference to FIGS. 4A and 4B and FIGS. 5A-5C.

FIGS. 4A and 4B and FIGS. 5A-5C show specific examples of multi-picture screen which are produced according to the process of FIG. 3.

FIGS. 4A and 4B show specific examples of multi-picture screen in which pieces of video of two programs are displayed.

In the multi-picture screen of FIG. 4A, a first video region and a second video region have the same size. Video that is supplied from the first separating module 201 via the first video decoder 203 is displayed in the first video region and audio corresponding to this video is output from the speakers 52. Video that is supplied from the second separating module 202 via the second video decoder 204 is displayed in the second video region and a subtitle corresponding to this video is shown in a subtitle display region that is adjacent to the second video region from below.

The first video region and the second video region have the same aspect ratio, which is the same as the aspect ratio of the pieces of video information of the programs that are input from the broadcast-wave processor 20 and the external apparatus IF module 21 to the first separating module 201 and the second separating module 202, respectively.

The user of the TV receiver 10 is allowed to switch from the state that audio corresponding to video that is displayed in the first video region is output to the state that audio corresponding to video that is displayed in the second video region is output by manipulating the particular manipulation key provided in the manipulation module 31 or the remote controller RC. When such switching is made, if the video that is displayed in the first video region is accompanied by a subtitle, the subtitle can be shown in the state that the audio corresponding to the video that is displayed in the second video region is output. The subtitle that accompanies the video that is displayed in the first video region is shown in a subtitle display region (not shown) that is adjacent to the first video region from below rather than the subtitle display region that is adjacent to the second video region from below.

The subtitle display region may be located over, rather than under, the second video region (or first video region). For example, in the multi-picture screen of FIG. 4A, the subtitle that accompanies the video that is displayed in the second video region may be shown in any region that is located on the right side (i.e., on the second video region side) of the boundary between the first video region and the second video region and that does not overlap with the second video region. On the other hand, the subtitle that accompanies the video that is displayed in the first video region may be shown in any region that is located on the left side (i.e., on the first video region side) of the boundary between the first video region and the second video region and that does not overlap with the first video region. That is, each subtitle display region is a region that is within the horizontal display range of the corresponding video display region and does not overlap with that video display region.

The characters of a subtitle that is shown in the subtitle display region may be changed in size from the characters that are supposed to be shown originally according to the size of the second video region (or first video region). For example, in the multi-picture screen of FIG. 4A, since the size of the second video region (or first video region) is approximately a half of the display screen size in each of the vertical direction and the horizontal direction, the size of the characters of a subtitle that is shown in the subtitle display region may be approximately a half of that of the characters that are supposed to be shown originally in each of the vertical direction and the horizontal direction.

In the multi-picture screen of FIG. 4B, a first video region is larger than a second video region. Also in this multi-picture screen, audio corresponding to video that is displayed in the first video region is output from the speakers 52 and a subtitle corresponding to video that is displayed in the second video region is shown in a subtitle display region that is adjacent to the second video region from below. The first video region and the second video region have the same aspect ratio.

The subtitle display region in which to show the subtitle that accompanies the video that is displayed in the second video region is a region that is within the horizontal display range of the second video display region and does not overlap with the second video region. The characters of a subtitle that is shown in the subtitle display region may be changed in size from the characters that are supposed to be shown originally according to the size of the second video region. For example, in the multi-picture screen of FIG. 4B, since the second video region is smaller than in the multi-picture screen of FIG. 4A, the characters of a subtitle that is shown in the subtitle display region may be smaller than in the multi-picture screen of FIG. 4A.

The subtitle display region may be located over, rather than under, the second video region. Also in the multi-picture screen of FIG. 4B, the subtitle that accompanies the video that is displayed in the second video region may be shown in any region that is located on the right side (i.e., on the second video region side) of the boundary between the first video region and the second video region and that does not overlap with the second video region.

The user of the TV receiver 10 is allowed to make switching as to the combinations of audio or a subtitle to be output or shown and video to be displayed in the first video region or the second video region by manipulating the particular manipulation key provided in the manipulation module 31 or the remote controller RC.

In the multi-picture screen according to the embodiment, pieces of video of more than two programs may be displayed. Specific examples of multi-picture screen in which pieces of video of more than two programs are displayed will be described below with reference to FIGS. 5A-5C.

FIGS. 5A-5C show specific examples of multi-picture screen in which pieces of video of four, six, and eight programs, respectively, are displayed.

In the multi-picture screen of FIG. 5A, first to fourth video regions are arranged on the single display screen. That is, FIG. 5A shows a specific example of multi-picture screen in which pieces of video of four programs are displayed.

In this multi-picture screen, as in the examples of multi-picture screen of FIGS. 4A and 4B, audio corresponding to video that is displayed in the first video region is output from the speakers 52. A subtitle that accompanies video that is displayed in the second video region is shown in a subtitle display region that is adjacent to the second video region from below, and a subtitle that accompanies video that is displayed in the fourth video region is shown in a subtitle display region that is adjacent to the fourth video region from below. Video that is displayed in the third video region is not accompanied by a subtitle, and hence no subtitle display region is located under the third video region. The third video region is thus larger than the second and fourth video regions.

That is, a region where to display video that is not accompanied by subtitles is set on the display screen with such a size as to accommodate both of the video and a subtitle (if it accompanied the video). In other words, a subtitle display region is secured by setting a region where to display video accompanied by subtitles smaller than a region where to display video that is not accompanied by subtitles. Whereas the first to fourth video regions are different in size, they have the same aspect ratio.

The size of characters of a subtitle that accompanies each of part of pieces of video that are displayed in the first to fourth video regions, the position of each subtitle display region, the switching of audio to be output from the speakers 52, and other features are approximately the same as in the multi-picture screen of FIGS. 4A and 4B which have two video display regions.

FIG. 5B shows a specific example of multi-picture screen in which pieces of video of six programs are displayed. In this multi-picture screen, a first video region is larger than the second to sixth display regions. FIG. 5C shows a specific example of multi-picture screen in which pieces of video of eight programs are displayed. In this multi-picture screen, a first video region is larger than the second to eighth display regions.

In the above examples of multi-picture screen, video that is displayed in each of the second, fourth, sixth, and eighth video regions is accompanied by subtitles and hence a subtitle display region where to display subtitles corresponding to the video is set under each of these video regions. Video that is displayed in each of the third, fifth, and seventh display regions is not accompanied by subtitles and hence no subtitle display region is set under each of these video regions. That is, the third, fifth, and seventh display regions are set on the display screen with a size that is equal to the size of the second, fourth, sixth, and eighth video regions plus the size of the subtitle display regions where to show the sets of subtitles that accompany the pieces of video that are displayed in these video regions. In other words, the subtitle display regions are secured by setting the second, fourth, sixth, and eighth video regions smaller than the third, fifth, and seventh display regions. Whereas the first to eighth video regions are different in size, they have the same aspect ratio. In this manner, as in the examples of multi-picture screen shown in FIGS. 5A-5C, pieces of video that are accompanied by subtitles and pieces of video that are not accompanied by subtitles may exist in mixture.

As described above, according to the embodiment, multi-picture screen is performed in which pieces of video of multiple programs are displayed simultaneously on the single display screen so as not to overlap with each other and a subtitle(s) corresponding to a particular piece(s) of video displayed is shown in the vicinity of it (or them) so as not to overlap with it (or them). In this multi-picture screen, since a subtitle corresponding to video of a content is shown in the vicinity of the video without blocking any portion of it, the video can be displayed in its entirety and the legibility of subtitle corresponding to the video can be increased.

While certain embodiments have been described, these embodiments have been presented by way of example only, and are not intended to limit the scope of the invention. Indeed, the novel apparatus and method described herein may be embodied in a variety of other forms; furthermore, various omissions, substitutions and changes in the form of the apparatus and the method described herein may be made without departing from the sprit of the invention. The accompanying claims and their equivalents are intended to cover such forms or modifications as would fall within the scope and sprit of the invention.

What is claimed is:

1. A video output apparatus comprising:
a first information receiving module configured to receive first video information and audio information;
a second information receiving module configured to receive second video information and subtitle information;
an audio output module configured to output an audio based on the audio information; and
a video output module configured to display a multi-picture screen, the multi-picture screen comprising a first region for displaying a first picture based on the first video information, a second region for displaying a second picture based on the second video information, and a third region for displaying a subtitle image based on the subtitle information,
wherein the third region is arranged within a given horizontal range where the second region exists, and the third region does not overlap with the second region.

2. The apparatus of claim 1 wherein the first region comprises a first aspect ratio based on the first video information, and the second region comprises a second aspect ratio based on the second video information.

3. The apparatus of claim 1 wherein the third region is arranged adjacently to the second region from above or below while not being overlapped with the first region.

4. The apparatus of claim 1 wherein the second information receiving module is configured to arrange the multi-picture screen to further include a fourth region for displaying a third picture based on third video information when the second information module receives the third video information; and an area of the fourth region is equal to a total area of the second region and the third region,

5. A video output method comprising:
receiving first video information and audio information;
receiving second video information and subtitle information;
outputting an audio signal based on the audio information; and
displaying a multi-picture screen, the multi-picture screen comprising a first region for displaying a first picture based on the first video information, a second region for displaying a second picture based on the second video information, and a third region for displaying a subtitle image based on the subtitle information,
wherein the third region is arranged within a given horizontal range where the second region exists, and the third region does not overlap with the second region.
